(19) United States
(12) Patent Application Publication
(10) Pub. No.: US 2010/0283560 A1
(43) Pub. Date: Nov. 11, 2010

(54) TRANSMITTER FOR INTRINSICALLY SAFE DATA-TRANSMISSION DEVICE

(76) Inventor: Rolf-Dieter SOMMER, Ostfildern (DE)

Correspondence Address: KF ROSS PC, 5683 RIVERDALE AVENUE, SUITE 203 BOX 900, BRONX, NY, 10471-0900, US

(21) Appl. No.: 12/667,202

(22) PCT Filed: Jun. 12, 2008
(86) PCT No.: PCT/EP08/05706

§ 371 Date: Dec. 29, 2009

(30) Foreign Application Priority Data
Aug. 4, 2007 (DE) 10 2007 036 964.8

(51) Int. Cl. H01P 1/00

(52) U.S. Cl. 333/99 R

(57) ABSTRACT

The invention relates to a mechanism designed for use in areas at risk of explosions, having at least two devices (1, 2) connected to one another by transmission means (3) for exchanging data, at least one of the devices (1, 2) being located in the area as risk of explosion and a decoupling network (4 to 11) being provided on the input side of the devices (1, 2), wherein the invention provides for the decoupling network (4 to 11) to be dimensioned and designed such that the energy that may be stored therein is not able to exceed a predeterminable maximum value.

The invention relates to a unit for use in areas at risk of explosion, having at least two devices that are connected to each other via a data carrier for exchanging data, where at least one of the devices is located in the area at risk of explosion and a decoupling network is provided on the input side of the device, according to the characteristics of the introductory clause of claim 1.

It is generally known to connect two devices to each other via a data carrier, such as a bus line, for exchanging data. Furthermore, it is known that at least one of the devices, preferably both devices (or more), is located in an area at risk of explosion. Examples for such areas at risk of explosion are mining or process-related systems that may include explosive gasses (such as in the case of refineries, or the like). It is therefore imperative to avoid the creation of any electric sparks in one of the devices near the data carrier or the environment thereof, which could lead to endangerment both of humans and of the process-related system.

Therefore, decoupling networks have become known that are connected upstream at the input side of the devices. These decoupling networks initially prevent impermissibly high energy, which may be generated in one of the devices and which may lead to an ignition spark, from being transferred to the data carrier. Conversely the same applies in that impermissibly high energy, which are supplied to the data carrier and may be transferred to the connected device, could come from the decoupling network of the device located in the area at risk of explosions. In this manner a first possibility is provided in order to avoid ignition sparks being generated in the area at risk of explosions.

However, this possibility is not good enough for securing areas at risk of explosions and for avoiding ignition sparks, since the possibility still exists that ignition sparks may be generated in case of a defect of a device or of the decoupling network.

Another possibility for avoiding the generation of ignition sparks has already been contemplated, namely limiting the maximum permissible voltage supply within a device to a certain value, thus resulting in the fact that no such energy level that may lead to an ignition spark may be generated within the device, and optionally within the connected decoupling network, which ignition spark could lead to an ignition of the explosive gas mixture. Although this further possibility has been proven satisfactory, both the expense for limiting the voltage supply within the device is high, and it still does not preclude that such energies, which could lead to an ignition spark for the explosive gas mixture, are not present within the decoupling network due to defects within the decoupling network despite limiting the voltage supply within the device.

The object of the invention is therefore to create a further possibility, such as with the data exchange between two devices that are in areas at risk of explosions, of effectively preventing the generation of ignition sparks that could lead to an explosion of a gas mixture. In particular, the invention provides for ensuring safe operation of the devices and the related components according to regulations such as the explosion protective standard IEC60079-x or the Ethernet Transmission Standard IEEE802.3 for exchanging data in areas at risk of explosions.

The object is attained by the characteristics of claim 1.

According to the invention the decoupling network or the components contained therein are dimensioned and embodied such that the energy that they can hold may not exceed a predetermined maximum value. The dimensioning is carried out such that the decoupling network is electrically operated within a range preventing the stored energy from exceeding the predetermined maximum value depending on how much energy is supplied from outside (such as via the data carrier or via the connected device) into the is decoupling network. In other words, the components of the decoupling network are dimensioned such that the decoupling network may in case of the worst possible case of defect only reach only a saturation region that is at the upper threshold of the energy transmission, the upper threshold being selected such that the energy could not lead to an effective ignition spark that would bring about an ignition of the gas mixture or other explosive media within the environment thereof.

As a further improvement of the invention the decoupling network of each device has at least one transformer comprising a core and a coil thereon, the core volume being dimensioned such that the energy that it can store may not exceed the predetermined maximum value. According to the improvement the principle of the invention is therefore to limit the storable energy in the transformer (spool or transformer) such that non-linear spools or transformers are created by selecting suitable core material and core volumes. This combination (core material and limiting the core volume) of the minimally necessary value for the transmission function and the use of additional power limiting-elements, such as Zener barriers, current limiters, and safety elements, can ensure that the energy stored in the magnetic field of the transformer remains below the predetermined maximum value.

As a further improvement of the invention the data carrier is a copper cable, i.e. a twisted-pair cable. The invention also makes it possible to install devices in areas at risk of explosions by the data carrier, and to enable an exchange of intrinsically safe signals between the devices.

As a further improvement of the invention the unit is an interface for connecting a data carrier or a dedicated module between the end of the data carrier and the input of the respective device. In this manner it is possible to use common a data carrier using common plug-in connectors and common transmission protocols in areas at risk of explosions, if the interface for the data carrier (example: Ethernet interface) is equipped with the decoupling network whose components are also within the device. A dedicated module is also conceivable that is connected between the data carrier and the common device in order to extend into the area at risk of explosions with the data carrier.

As a further improvement of the invention the devices, Ethernet switches, or terminals connected to the data carrier may be controllers, actuators, or sensors, the transmission between the two devices being carried out by the data carrier in Ethernet format. In this manner the invention makes it now possible to operate currently known Ethernet switches or terminals whose connections from the data carrier not been suitable for use in areas at risk of explosions, and particularly had not been rated for the same, in these areas. In this manner the invention creates the possibility of an intrinsically safe transmission of Ethernet signals, or also of other signals between two or more devices in areas at risk of explosions for the first time.

Overall, the invention thus creates the possibility of intrinsically safe operation of devices in areas at risk of explosions in a reliable manner utilizing simple means, and meeting respective regulations (such as the standards stated above, or others).

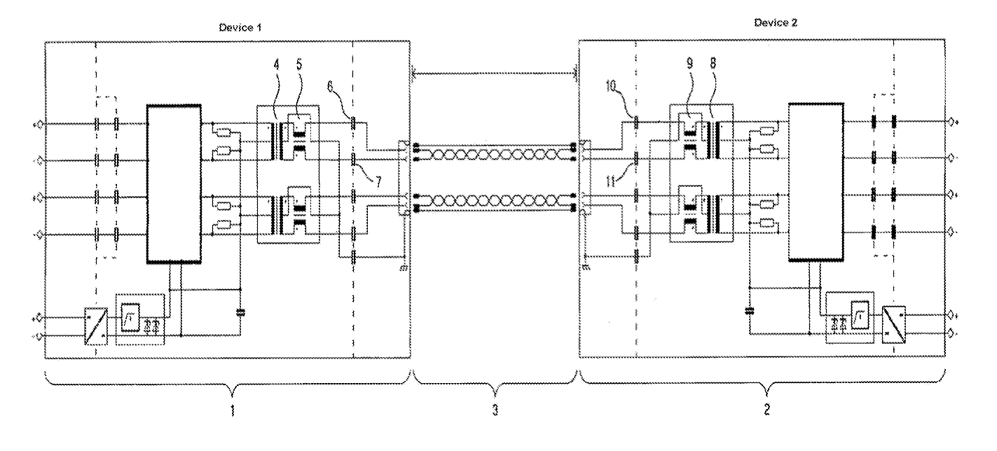

An embodiment of the system is shown in detail in FIG. 1.

Reference numerals 1 and 2 denote devices, particularly devices having an Ethernet interface, that are installed in areas (zone 1 and zone 2) at risk of explosions. The two devices 1 and 2 are connected to each other via a data carrier 3, such as copper cables, for the purpose of an exchange of data. It should be noted that more than two devices 1 and 2 may be present that in this case are connected with each other via further a data carrier 3 for the purpose of an exchange of data, and the constellation described above forms a network of a plurality of devices.

A decoupling network 4 to 7 is present on the input side of the first device 1, while the second device 2 also has a decoupling network 8 to 11 on the input side. The decoupling network is comprised of transformers 4 and 5 in the first device 1, or 8 and 9 in the second device 2, and capacitors 6 and 7 in the first device 1 and capacitors 10 and 11 in the second device 2. In this embodiment the construction of the decoupling network of the devices 1 and 2 is the same, but may also be different.

In particular the transformers 4 and 8 of both devices 1 and 2, which decouple the output signals of the first device 1 or of the second device 2 from the data carrier, are coils or transformers having a core and a winding thereon, the transformers 4 and 8 are dimensioned such that the energy that they can hold may not exceed a predetermined maximum value. The core material, the core volume, and the winding thereon are dimensioned such that the maximum energy stored in the magnetic field of the transformer 4 and 8 remains below the predetermined maximum threshold value.

### LIST OF REFERENCE SYMBOLS

1 device
2 device
3 data carrier
4 transformer
5 transformer
6 capacitor
7 capacitor
8 transformer
9 transformer
10 capacitor
11 capacitor

1. A unit for use in areas at risk of explosions, having at least two devices connected to each other via a data carrier for exchanging data, at least one of the devices being in the area at risk of explosions, a respective decoupling network being provided on the input side of each of the devices, wherein the decoupling networks are each dimensioned and embodied such that the energy that they can hold may not exceed a predetermined maximum value.

2. The unit according to claim 1, wherein the decoupling network of a device has at least one transformer comprising a core and a winding arranged thereon, the core material and the core volume being dimensioned such that the energy that they can hold may not exceed the predetermined maximum value.

3. The unit according to claims 1 that wherein the data carrier is a copper cable, particularly a twisted-pair cable.

4. The unit according to claim 1, wherein the unit is integrated into an interface for connection to the data carrier, or forms a dedicated module that is connected between the end of the data carrier and the input of the respective device.
